(19) United States
(12) Patent Application Publication
(10) Pub. No.: US 2011/0243448 A1
(43) Pub. Date: Oct. 6, 2011

(54) HANDWRITTEN DATA MANAGEMENT SYSTEM, HANDWRITTEN DATA MANAGEMENT PROGRAM AND HANDWRITTEN DATA MANAGEMENT METHOD

(75) Inventors: Yoichi Kawabuchi, Hachioji-shi (JP); Moeko Hagiwara, Ichikawa-shi (JP); Yoko Oehara, Machida-shi (JP)

(73) Assignee: Konica Minolta Business Technologies, Inc., Tokyo (JP)

(21) Appl. No.: 13/077,204

(22) Filed: Mar. 31, 2011

(30) Foreign Application Priority Data
Apr. 5, 2010 (JP) 2010-086992

(51) Int. Cl. G06K 9/00

(52) U.S. Cl. 382/187

(57) ABSTRACT

A handwritten data management system having an input device, and a handwritten data management apparatus having a screen to draw an image, wherein the input device has a sensor section to detect input device conditions, and sends the condition information to the management apparatus, wherein the management apparatus includes: a graphic data extracting section which extracts basic drawing data from trajectories of the input device on the screen; a break discrimination section which discriminates a break portion of the basic drawing data based on the condition information, and determines its break level by referring to a previously stored table; and a group data management section which groups plural basic drawing data, and registers the group data at a higher hierarchy level, and further sequentially groups the plural group data based on the break level, and registers a higher level group data at a higher hierarchy level.

### CROSS REFERENCE TO RELATED APPLICATION

The present application is based on Japanese Patent Application No. 2010-086992 filed with Japanese Patent Office on Apr. 5, 2010, the entire content of which is hereby incorporated by reference.

### BACKGROUND OF THE INVENTION

1. Technical Field

The present invention relates to a handwritten data management system, a handwritten data management program, and a handwritten data management method, and particularly relates to those system, program and method for grouping and managing handwritten characters, figures, graphics and the likes.

2. Description of Prior Art

In recent years, pen tablets provided with a pen and a touch-panel are becoming common and used for designs and creating documents. In these pen tablets, when a pen is moved on the touch panel a trajectory of the pen is displayed on a touch panel screen, and the drawn characters, figures or graphics can be memorized as data. By reusing the data, a design or a document can be effectively created.

Since the characters, figures, graphics and the likes are formed by combinations of plural lines, the plural lines are necessary to be registered by grouping. Regarding methods of the grouping, there have been various proposals. For example, Unexamined Japanese Patent Application Publication No. 2009-187218 (Patent Document 1) discloses an input display device which groups handwritten information, based on identification information attached to the handwritten information, to a single display information group. Further, Unexamined Japanese Patent Application Publication No. 1997-311855 (Patent Document 2) discloses a handwritten data editing device having a classifying means for classifying chirographic data into a character group indicating chirographic data constituting characters and figure group indicating chirographic data constituting figures.

Further, there are various proposals regarding methods for recognizing drawn characters and figures. For example, Unexamined Japanese Patent Application Publication No. 1994-95800 (Patent Document 3) discloses a pen-grip system input device provided with a detection means for detecting a pressure change of writer's finger, and an analyzing means which obtains an output indicating an output change to form a unit waveform, analyzes wave characteristics of the waveform, and compares said wave characteristics with the wave characteristics of the character, numeric character, figure and code of the writer which have been preliminary studied and memorized, and recognizes the character, numeric character, figure and code which are drawn by said writer. Further, Unexamined Japanese Patent Application Publication No. 1992-323789 (Patent Document 4) discloses a recognition method which, in character recognition of handwritten characters, extracts as the characteristic data a number of times when a pen is kept off the tablet, and position vector information.

However, according to the conventional technologies, in order to group the handwritten characters, figures and graphics, it is necessary to select items desired to be grouped and to manually conduct the setting of grouping, which causes a problem of making the operation complicated. With respect to this problem, Patent Document 1 describes to assume the break of time elapse as the discrimination information, however, also in this system an operator needs to execute the separation of time elapse, which being complicated.

Further, according to the conventional technologies, there has been a problem that appropriate grouping of the characters, figures, and the graphics according to the intention of the operator is not capable. With respect to this problem, Patent Document 2 describes to identify a stroke of an item, whose both length of a stroke and length of a longer base of a rectangle which circumscribes said stroke are greater than a prescribed threshold value, as a stroke of the figure, and the other stroke as a stroke of the character. However, by this method it is not capable of classifying and grouping the figure. Further, according to Patent documents 3 and 4, recognition of previously registered characters and numeric characters and the likes is capable, however recognition of unregistered figures and graphics is not possible, therefore even in case of utilizing this technology, it is not possible to classify and group the figures and graphics in various shapes. And in order to recognize the characters, numeric characters and the likes a character recognition engine is required, which makes the system complicated.

Further, in cases of forming and grouping the figures or graphics which are composed of a plurality of structural elements, final forms of the figures or graphics can be reusable, however figures or graphics of each structural element can not be reusable, thus it is not possible to effectively form designs or documents by utilizing the previously formed figures or graphics, which has been also a problem.

The present invention is performed in view of the above problems, and its main object is to provide a handwritten data management system, a handwritten data management program, and a handwritten data management method where handwritten characters, features, and graphics and the likes can be properly grouped with simple configurations.

### SUMMARY OF THE INVENTION

In order to achieve the above described object, a handwritten data management system reflecting one aspect of the present invention is structured with an input device, and a handwritten data management apparatus having a screen on which the input device draws an image, wherein the input device has a sensor section to detect a condition of the input device, and a communication control module to transmit condition information to the handwritten data management apparatus; and the handwritten data management apparatus includes: a graphic data extracting section which extracts graphic data as basic drawing data from trajectories of the input device on the screen; a break discrimination section which discriminates a break portion of the basic drawing data based on the condition information, and determines a break level of the break portion by referring to a previously stored table; and a group data management section which groups a plurality of the basic drawing data into a group data, and registers the group data at a higher hierarchy level next to a hierarchy level of the basic drawing data, and further sequentially groups a plurality of the group data into a higher level group data based on the break level, and registers the higher level group data at a higher hierarchy level next to a hierarchy level of the group data.

A handwritten data management program reflecting another aspect of the present invention is a program for causing an apparatus comprising a screen on which an input device draws an image to perform functions of a graphic data extracting section which extracts graphic data as basic drawing data from trajectories of the input device on the screen; a break discrimination section which discriminates a break portion of the basic drawing data based on condition information transmitted from the input device, and determines a break level of the break portion by referring to a previously stored table; and a group data management section which groups a plurality of the basic drawing data into a group data, and registers the group data at a higher hierarchy level next to a hierarchy level of the basic drawing data, and further sequentially groups a plurality of the group data into a higher level group data based on the break level, and registers the higher level group data at a higher hierarchy level next to a hierarchy level of the group data.

A handwritten data management method reflecting another aspect of the present invention is a method for utilizing a handwritten data management system configured with an input device, and a handwritten data management apparatus having a screen on which the input device draws an image, including: a drawing step of drawing on the screen of the handwritten data management apparatus by utilizing the input device; a detecting step of detecting a condition of the input device; a transmitting step of transmitting condition information of the input device to the handwritten data management apparatus; a graphic data extracting step of extracting graphic data as basic drawing data from trajectories of the input device on the screen; a break discrimination step of discriminating a break portion of the basic drawing data based on the condition information of the input device, and determining a break level of the break portion by referring to a previously stored table; and a group data management step of grouping a plurality of the basic drawing data into a group data based on the break level, registering the group data at a higher hierarchy level next to a hierarchy level of the basic drawing data, and further sequentially grouping a plurality of the group data based on the break level into a higher level group data, and registering the higher level group data at a higher hierarchy level next to a hierarchy level of the group data.

### BRIEF DESCRIPTION OF THE DRAWINGS

These and other objects, advantages and features of the invention will become apparent from the following description thereof taken in conjunction with the accompanying drawings in which:

FIG. 1 is a plan view schematically illustrating a configuration of the handwritten data management system relating to an embodiment of the present invention;

FIG. 2 is a control block diagram illustrating a configuration of the handwritten data management apparatus relating to an embodiment of the present invention;

FIG. 3 is a control block diagram illustrating a configuration of an input device (pen input device) relating to an embodiment of the present invention;

FIG. 4 is a drawing illustrating an example of hierarchal group structure;

FIG. 5 is a drawing illustrating an example of group data configuration;

FIG. 6 is a flowchart diagram illustrating a registration procedure of the group data relating to an embodiment of the present invention;

FIGS. 7a-7c are drawings illustrating an examples of a break condition table; and

FIG. 8 is a drawing schematically illustrating a method of grouping based on a break level.

### DETAILED DESCRIPTION OF THE PREFERRED EMBODIMENT

As described in the description of the prior art, creations of designs or documents have been conducted by utilizing the handwritten characters, figures and graphics, however according to the conventional methods, operations for grouping the characters, figures and graphics have been complicated, and an appropriate grouping along the operator's intention has been difficult, further there has been problems that reusing the figure or graphic of each structural element is not possible, and the likes.

Therefore, in an embodiment of the present invention, in order to enable the appropriate grouping of the characters, figures and graphics along the operator's intention, by utilizing information of such as a time of the input device leaving off, a pressure of gripping the input device, and angle of the input device, break portion of the drawing is discriminated based on these information. Then, the break level is determined by referring to the previously registered table, and the grouping of the characters, figures and graphics are conducted based on the break level.

Further, in order to enabling the reuse of the figure or graphic of each structural element, grouping is conducted based on the break level, in plural levels such as line level, code level, object level, group level, and the likes, and group data of each level are registered in hierarchical structure.

### Embodiment

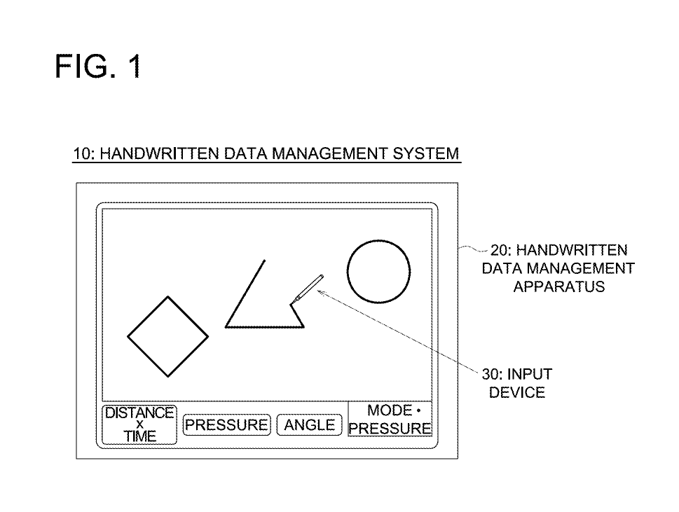

In order explain further in detail an embodiment of the present invention, the handwritten data management system, a handwritten data management program, and handwritten data management method relating to an embodiment of the present invention will be described with referring to FIGS. 1 to 8.

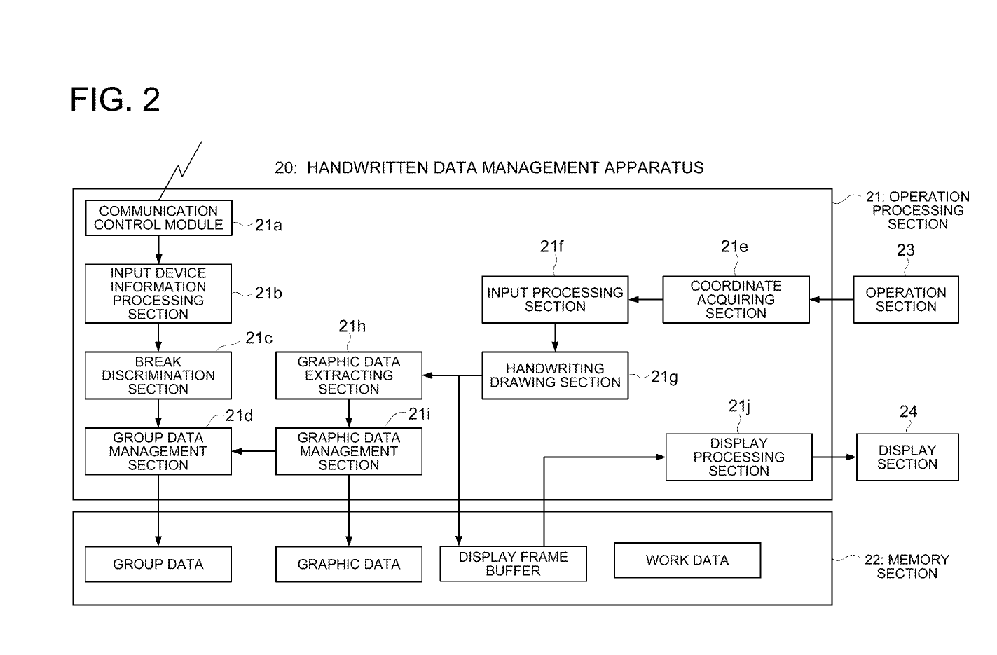

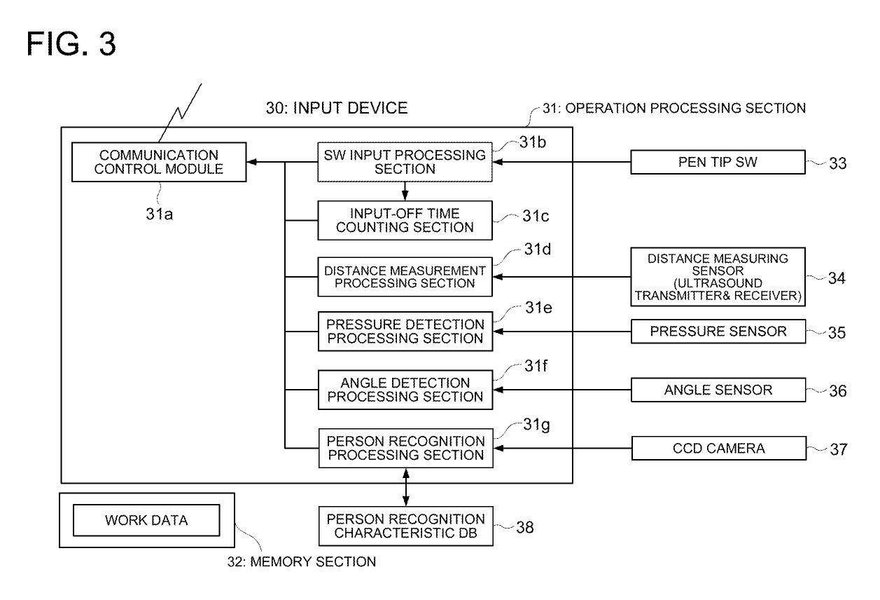

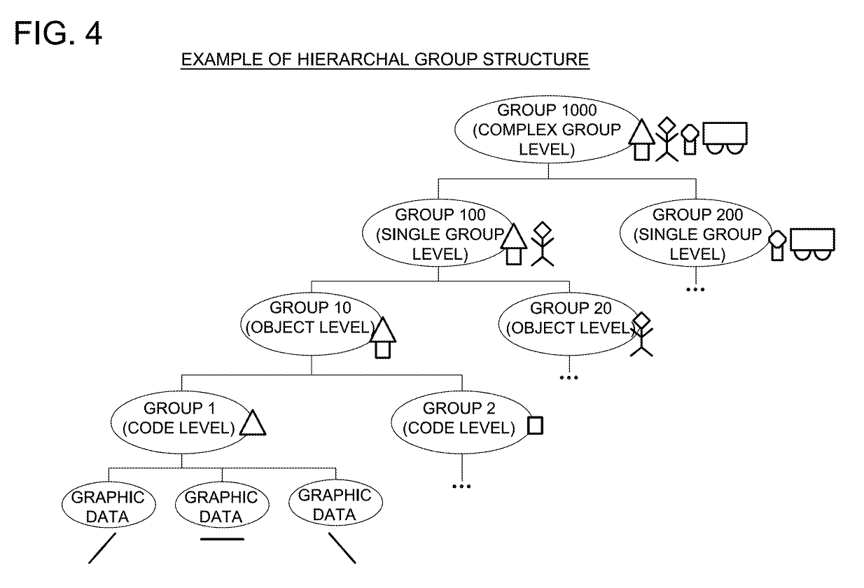

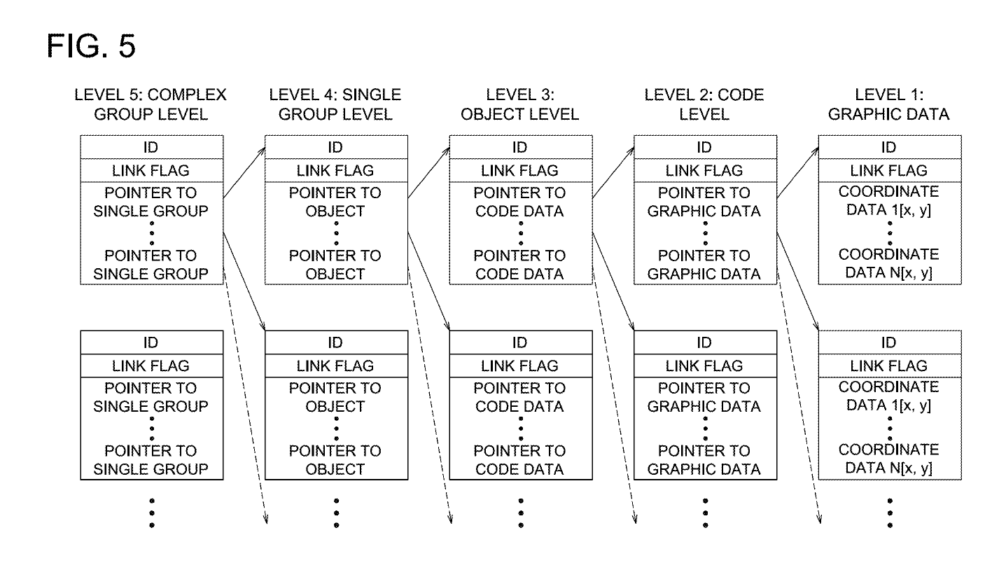

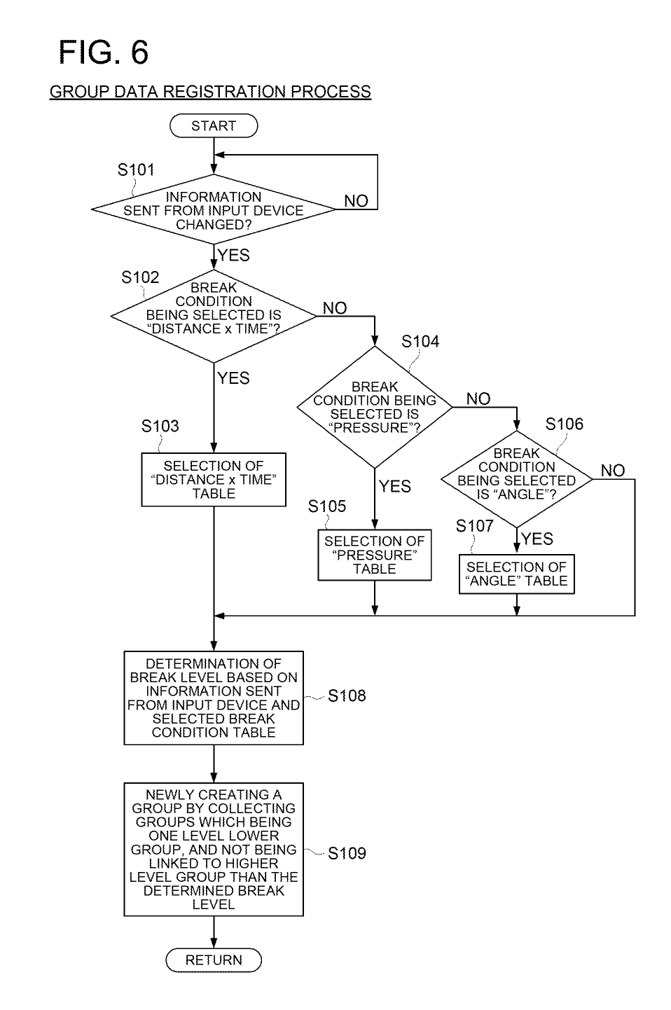

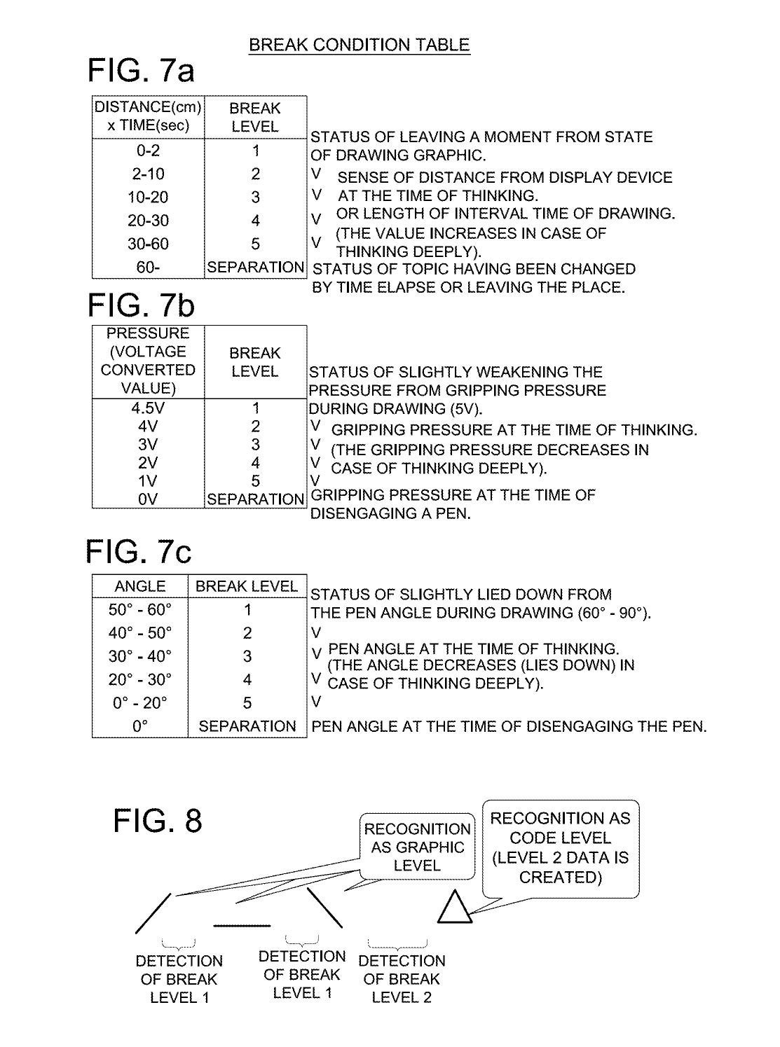

FIG. 1 is a drawing schematically illustrating a configuration of the handwritten data management system relating to an embodiment of the present invention; FIG. 2 is a control block diagram illustrating a configuration of the handwritten data management apparatus; FIG. 3 is a control block diagram illustrating a configuration of an input device; FIG. 4 is a drawing illustrating an example of hierarchal group structure; FIG. 5 is a drawing illustrating an example of group data configuration; FIG. 6 is a flowchart diagram illustrating a registration procedure of the group data; FIG. 7 is a drawing illustrating an example of a break condition table; and FIG. 8 is a drawing schematically illustrating a method of grouping.

As shown in FIG. 1, the handwritten data management system 10 of the present embodiment is configured with handwritten data management apparatus 20 for grouping and registering the data (hereinafter referred as handwritten data) such as the handwritten characters, figures, and graphics, and input device 30 for drawing the characters, figures and graphics. Each device will be described in detail below.

### [Handwritten Data Management Apparatus]

As shown in FIG. 2, the handwritten data management apparatus 20 is configured with operation section 23 for receiving drawings such as the characters, figures and graphics formed by input device 30, display section 24 for displaying the inputted characters, figures and graphics, and a control unit for controlling these sections and managing the handwritten data.

The control unit is configured with operation processing section 21 such as CPU (Central Processing Unit) and memory section 22 such as RAM (Random Access Memory) and HDD (Hard Disk Drive). Operation processing section 21 is configured with communication control module 21a, input device information processing section 21b, break discrimination section 21c, group data management section 21d, coordinate acquiring section 21e, input processing section 21f, handwritten drawing section 21g, graphic data extracting section 21h, graphic data management section 21i, and display processing section 21j, and functions of these sections are executed as hardware or as software.

Communication control module 21a is an interface to connect with input device 30, and receives various type of information from input device 30 by using such as wire communication, wireless communication, infrared ray communication, and Bluetooth™. Input device information processing section 21b processes the information (such as the information of input-off time, distance, pressure angle and photographed image that will be described later), and sends the information to break discrimination section 21c in cases where break discrimination is required. Break discrimination section 21c determines a break level by referring to a previously stored table (a break condition table to be described later), and sends the result to group data management section 21d. Based on the result received from break discrimination section 21c, group data management section 21d sequentially groups the graphic data received from graphic data management section 21i, makes identifiable (for example by adding ID), and registers as hierarchical structure group data into memory section 22.

Coordinate acquiring section 21e receives signals from operation section 23 to acquire coordinates (x, y coordinates), and sends to input processing section 21e Input processing section 21f executes input edge processing (processing for specifying a starting point and ending point of the drawing) with respect to the coordinates acquired by coordinate acquiring section 21e and sends to hand written drawing section 21g. Hand written drawing section 21g creates drawing information based on the coordinates applied with the input edge processing, sends to graphic data extracting section 21h, and stores in memory section 22 (display frame buffer). Graphic data extracting section 21h extracts the data (hereinafter referred as graphic data) which will be a basic unit of characters, figures or graphics, based on the drawing information. Graphic data management section 21i makes the graphic data, extracted by graphic data extracting section 21h, identifiable (for example by adding ID), registers the data in memory section 22, and sends to group data management section 21d.

Display processing section 21j takes out the drawing information from memory section 22 (display frame buffer) and displays on display section 24.

Operation section 23 is a pressure sensitive touch panel where lattice-like transparent electrodes are arranged on display section 24, detects XY-coordinate of a point pushed by a finger or a touch pen with voltage values, and output the detected position signals as operation signals to operation processing section 21 (coordinate acquiring section 21e).

Display section 24 is configured with such as an EPD (Electrophoretic Display), LCD (Liquid Crystal Display), and organic EL (electroluminescence), and displays the drawing information according to instructions from operation processing section 21 (display processing section 21j).

### [Input Apparatus]

As shown in FIG. 3, input device 30 is a pen-typed device configured with a sensor section including pen tip SW (contact sensor) 33, distance measuring sensor 34, pressure sensor 35, angle sensor 36, CCD (Charge Coupled Device) camera 37, a controller to control these elements, person recognition characteristic DB 38 to register characteristic information of a human face, and the likes.

The controller is configured with operation processing section 31 such as CPU, memory section 32 such as RAM and HDD. Operation processing section 31 is configured with communication control module 31a, SW input processing section 31b, input-off time counting section 31c, distance measurement processing section 31d, pressure detection processing section 31e, angle detection processing section 31f, and person recognition processing section 31g, and the likes, and functions of these sections are executed as hardware or as software.

Communication control module 31a is an interface to connect with handwritten data management apparatus 20, and sends condition information of input device 30 acquired by each of sections described below toward handwritten data management apparatus 20. Based on signals from pen tip SW 33, SW input processing section 3 lb judges whether input device 30 has touched on handwritten data management apparatus 20. Based on the judgment result of SW input processing section 31b, input-off time counting section 31c counts the time when input device 30 is not touching handwritten data management apparatus 20 (herein after referred as input-off time). Distance measurement processing section 31 d acquires a distance by processing the signals sent from distance measuring sensor 34. Pressure detection processing section 31e acquires a pressure (gripping pressure of input device 30) by processing the signals sent from pressure sensor 35. Angle detection processing section 31f acquires an angle (inclined angle of input device 30) by processing the signals sent from angle sensor 36. Referring to the characteristic information registered in person recognition characteristic DB 38, person recognition processing section 31g recognizes a person by processing the photographed image sent from CCD camera 37.

Pen tip SW 33, being a switch provided at the leading end of input device 30, sends ON or OFF signal to SW input processing section 3 lb when the SW 33 touches handwritten data management apparatus 20.

Distance measuring sensor 34, being configured for example with an ultrasonic transmitter and an ultrasonic receiver, receives a ultrasonic wave having been transmitted from the ultrasonic transmitter and reflected from handwritten data management apparatus 20, measures the distance from data management apparatus 20 based on time difference between transmission and receiving, and sends the signal according to the distance toward distance measurement processing section 31d.

Pressure sensor 35 being configured with such as a piezoelectric element arranged at the part of being gripped in input device 30, detects the pressure of gripping input device 30, and sends the signals according to the pressure toward pressure detection processing section 31e.

Angle sensor 36 being configured with such as an acceleration sensor and a gyro sensor, detects the inclination of input device 30 against a horizontal plane, and sends the signals according to the angle toward angle detection processing section 31f.

CCD camera 37 being configured with such as a CCD device provided at the base of (operator's side end portion) input device 30 and having two dimensionally arranged pixels, and a signal processing section to sequentially reads out charges accumulated in each pixels sends the photographed image toward person recognition processing section 31g.

FIGS. 1 to 3 show an example of handwritten data management system 10 of the present embodiment, and its configuration and control are arbitrarily changeable. For example, although in the present invention, pen tip SW 33, distance measuring sensor 34, pressure sensor 35, angle sensor 36, and CCD camera 37 are provided on input device 30, any of these may be omitted and further CCD camera 37 may be provided at the side of handwritten data management apparatus 20 in accordance with the break discrimination method being described later.

Next, the data structure to be registered by the above configured handwritten data management system 10 will be described.

FIG. 4 schematically shows a hierarchal structure of the data, where three basic drawing data (graphic data) are grouped, and group data of code level (group 1 data) is formed at a higher hierarchy level next to the graphic level, and a plurality of group data (data of group 1 and group 2) of code levels are grouped to form object level group data (group 10 data) at a higher hierarchy level next to code level. Similarly, a plurality of group data (data of group 10 and group 20) of object levels is grouped to form single group level group data (data of group 100) at a higher hierarchy level next to the object level. Similarly, a plurality of single group level group data (data of group 100 and group 200) of object levels is grouped to form complex group level group data (data of group 1000) at a higher hierarchy level next to the single group level. Wherein, the code level, object level, single group level, and complex group level are the classification of convenience, and those names and hierarchy structure may be arbitrarily changeable.

FIG. 5 shows the information stored in each hierarchy data. In the graphic data of the lowest level, described are ID for identifying the data, a link flag indicating whether the data is correlated as a group data, and coordinate of each point. Further in a higher hierarchy level data than the graphic data (data of code level, object level, single group level, and complex group level), described are ID for identifying the data, a link flag indicating whether the data is correlated as a group data, and a pointer to specify the lower hierarchy level data.

In order to register the data in hierarchy structure as shown in FIGS. 4 and 5, it is necessary to recognize the data of basic unit (graphic data) such as data of line, and to group the graphic data, and further it is necessary to group the grouped graphic data into upper level data. Thus, in cases of graphic data recognition or grouping, if requiring the operator for each setting, the operation procedure will be complicated. Therefore, in the present embodiment, on input device 30, pen tip SW 33, distance measuring sensor 34, pressure sensor 35, angle sensor 36, and CCD camera 37 are provided, and by utilizing the information acquired by these detection means, break portions of the character, figure, or graphic are discriminated to determine the break level by referring to the previously stored table. Based on the break level, the graphic data is grouped, and sequentially further grouped into higher level.

Procedures for grouping the data based on the break level will be described below by referring to the flow chart of FIG. 6. In the explanation below, it is assumed that as discrimination conditions of the break portion, either one of “distance×time”, “pressure”, and “angle” is previously selected. And the result of the selection as well as a table to be utilized for break discrimination are previously stored in memory section 22 of handwritten data management apparatus 20.

When a user starts drawing using input device 30, handwritten data management apparatus 20 acquires the coordinate of being touched by input device 30 based on signals from operation section 23, executes input edge processing to create drawing information, and displays the drawing information on display section 24, and further, when graphic data extracting section 21h extracts graphic data from the drawing information, graphic data management section 21i makes the graphic data identifiable and sends to group data management section 21d.

Meanwhile, output signals of pen tip SW 33, distance measuring sensor 34, pressure sensor 35, angle sensor 36, and CCD camera 37 are processed by the controller of input device 30, and sent to handwritten data management apparatus 20 as the condition information. Input device information processing section 21b of handwritten data management apparatus 20 determines whether the received condition information changed (S 101), and sends the received condition information to break discrimination section 21c, in cases where the condition information has changed (for example, the case where input device 30 has left handwritten data management apparatus 20, or the grip pressure or inclined angle of input device 30 has changed). Since the time when the condition information sent from input device 30 changes is when the operation condition of input device 30 changes, said time coincides with the timing when the graphic data is sent to group data management section 21d.

Next, break discrimination section 21c determines whether “distance×time” is selected as the condition for discriminating a break portion (S102), and in cases where “distance×time” is selected, selects for example a table shown in FIG. 7a (S103).

In cases where “distance×time” is not selected as the condition for discriminating the break portion, break discrimination section 21c determines whether “pressure” is selected (S104), and in cases where “pressure” is selected, selects for example a table shown in FIG. 7b (S105).

In cases where “pressure” is not selected as the condition for discriminating the break portion, break discrimination section 21c determines whether “angle” is selected (S106), and in cases where “angle” is selected, selects for example a table shown in FIG. 7c (S107).

Next, break discrimination section 21c determines the break level based on the information sent from input device 30 and the table selected in the above step (S 108).

To be more specific, in cases where the condition information sent from input device 30 includes the input-off time measured by input-off time counting section 31c and the distance acquired by distance measurement processing section 31d, by multiplying input-off time (second) by distance (cm), the break level is determined based on to which region the multiplied value belongs in the table of FIG. 7a. For example, in the case where the input-off time is short (for example 1 sec), and the distance between input device 30 and handwritten data management apparatus 20 is short (for example 1 cm), since it is assumed as the state of leaving a moment from the state of drawing, this break level is determined to be “1”. While, in the case where the input-off time is long, and the distance is large, since it is assumed as the state of thinking deeply, and when the value multiplied input-off time by the distance becomes equal to or more than a predetermined value (for example 60 sec), this break level is determined to be “separation”.

In cases where the condition information sent from input device 30 is “pressure” processed by pressure detection processing section 31e, the break level is determined based on to which region the value of pressure belongs in the table of FIG. 7b. For example, in the case where the gripping pressure of input device 30 is slightly less (voltage converted value being 4.5 v) than the gripping pressure during drawing (5 v), since it is assumed as the state of slightly weakening the pressure from the state of drawing, this break level is determined to be “1”. While, in the case where the pressure is small enough (for example 0 v), since it is assumed as the state of not gripping input device 30, this break level is determined to be “separation”.

In cases where the condition information sent from input device 30 is “angle” processed by angle detection processing section 31f, the break level is determined based on to which region the value of angle belongs in the table of FIG. 7c. For example, in the case where the inclined angle of input device 30 is slightly less (for example, 50-60°) than the inclined angle during drawing (60-90°), since it is assumed as the state of having a short rest of drawing, this break level is determined to be “1”. While, in the case where angle is small enough (for example 0°, since it is assumed as the state of not holding input device 30, this break level is determined to be “separation”.

Although in FIGS. 7a-7c, the break levels are set to be 6 levels, the number of levels may be arbitrarily set, and if the more number of levels are set, the more number of hierarchy levels of group data may be formed. For example, in a case where the break level is set to be n levels, the group data may be registered inn hierarchy levels in maximum.

Next, by referring to graphic data sent from graphic data management section 21i and the registered group data, group data management section 21d creates a group by collecting the data which being classified by the break level one level lower than the determined break level and being not linked to higher level group, and updates the group data (S109).

For example, the case where three patterns, each being recognized as graphic levels, are drawn as shown in FIG. 8 will be explained as an example. In cases where break level “1” is detected after the first and the second patterns are drawn, since there is no break level lower than said break level, grouping is not executed. In cases where break level “2” is detected after the third pattern is drawn, since there is a pattern which being classified by the break level “1” one level lower than the detected break level “2” and the patterns being not linked to higher level group, the three patterns are collected to form a group data (figure of triangle in code level).

Similarly an example of the case where a quadrangle is drawn by four patterns, each being recognized as graphic levels, will be explained. In cases where break level “1” is detected after the first to third patterns are drawn, since there is no break level lower than said break level, grouping is not executed. In cases where break level “2” is detected after the fourth pattern is drawn, since there is a pattern which being classified by the break level “1” one level lower than the detected break level “2” and the patterns being not linked to a higher level group, the four patterns are collected to form a group data (figure of quadrangle in code level).

Further, in the case where after two patterns each being recognized as code level are drawn, break level “3” is detected, since there are two code level patterns which being classified as the break level “2” one level lower than the detected break level “3”, and the patterns being not linked to higher level group, the two code level patterns are collected to form a group data (figure of house in object level). And by similarly repeating this processing, a group data of single group level and a group data of complex group level are created to form the group data of hierarchy structure as shown in FIG. 4.

Further as necessary, by referring to person recognition characteristic DB 38, person recognition processing section 31g specifies a person based on the image photographed by CCD camera 37 of input device 30, and the configuration may be realized where only the drawings made by the specified person are grouped.

In this way, the operator previously selects either one of “distance×time”, “pressure”, or “angle”, as a discrimination condition, and by change of “distance×time”, “pressure”, or “angle” at the break portion of drawing the handwritten data can be registered in hierarchy structure according to the break level. Therefore the operator needs not select the drawings to be grouped, or set the beak portion, which improves convenience. Further, since the present embodiment is not the method where figures are recognized by utilizing the previously stored characteristic information, grouping can be performed on arbitrary shaped drawings or pictures. Furthermore, according to the present embodiment, not only the final form handwritten data, but the handwritten data of each structural element are registered, therefore, the handwritten data of each structural element can be also reused, to make creation of designs or documents easy.

The present invention is not restricted to the above described embodiment, and the structure or the control of the invention may be arbitrarily changeable without departing from the scope of the invention.

For example, in the above described embodiment, although the case of registering the figures or graphics is described, the embodiment may be similarly applied to the case of registering characters. Further, in the above described embodiment, although as the break discrimination conditions “distance×time”, “pressure”, and “angle” are describe as examples, other conditions such as a drawing pressure, drawing speed, and drawing size may be utilized as the break discrimination conditions. And, combinations of these conditions may be utilized as well.

Further, in the above described embodiment, although the break level is discriminated based on the information sent from input device 30, the other configuration may be possible where display section 24 of handwritten data management apparatus 20 displays an input switch, and the break level may be set according to the mode of touching the input switch (for example, when touched one time the break level is set “1”, and when touched two times the break level is set “2”). Even in the case of conducting these operations, the grouping can be performed more simply and surely than the conventional method.

According to the handwritten data management system, a handwritten data management program, and a handwritten data management method of the present invention, handwritten characters, features, and graphics and the likes can be properly grouped with simple configurations.

The reason is that the handwritten data management apparatus discriminates a break portion of a drawing, based on the time when the input device is leaving, and gripping pressure of the input device, angle of the input device and the like, then based on the break level, automatically groups and registers the characters, figures, and graphics in hierarchal structure.

The present invention is applicable to a system provided with a pen-type input device and an apparatus having a touch panel screen.

What is claimed is:

1. A handwritten data management system comprising:
an input device, and
a handwritten data management apparatus having a screen on which the input device draws an image, wherein
the input device comprises:
a sensor section to detect a condition of the input device; and
a communication control module to transmit condition information to the handwritten data management apparatus, wherein
the handwritten data management apparatus comprises:
a graphic data extracting section which extracts graphic data as basic drawing data from trajectories of the input device on the screen;
a break discrimination section which discriminates a break portion of the basic drawing data based on the condition information, and determines a break level of the break portion by referring to a previously stored table; and a group data management section which groups a plurality of the basic drawing data into a group data, and registers the group data at a higher hierarchy level next to a hierarchy level of the basic drawing data, and further sequentially groups a plurality of the group data into a higher level group data based on the break level, and registers the higher level group data at a higher hierarchy level next to a hierarchy level of the group data.

2. The handwritten data management system of claim 1, wherein the group data management section groups and registers the basic drawing data which being classified with one level lower break level than the determined break level and being not registered in a higher level group data or the group data.

3. The handwritten data management system of claim 1, wherein the input device comprises:
a distance measuring sensor to measure a distance between the screen of the handwritten data management apparatus and the input device; and
a contact sensor to detect a contact between the screen and the input device,
wherein the input device transmits the distance between the screen of the handwritten data management apparatus and the input device, and a time period when the input device is not contacting the handwritten data management apparatus, as the condition information,
wherein the break discrimination section determines the break level of the break portion, based on a value obtained with multiplying the distance by the time period.

4. The handwritten data management system of claim 1, wherein the input device comprises a pressure sensor to measure a gripping pressure caused by an operator, and the input device transmits the gripping pressure,
wherein the break discrimination section determines the break level of the break portion, based on the gripping pressure.

5. The handwritten data management system of claim 1, wherein the input device comprises an angle sensor to measure an inclination angle of the input device against a horizontal plane, and the input device transmits the inclination angle,
wherein the break discrimination section determines the break level of the break portion, based on the inclination angle.

6. A computer-readable storage medium stored therein a handwritten data management program for causing an apparatus comprising a screen on which an input device draws an image to perform functions of:
a graphic data extracting section which extracts graphic data as basic drawing data from trajectories of the input device on the screen;
a break discrimination section which discriminates a break portion of the basic drawing data based on condition information transmitted from the input device, and determines a break level of the break portion by referring to a previously stored table; and
a group data management section which groups a plurality of the basic drawing data into a group data, and registers the group data at a higher hierarchy level next to a hierarchy level of the basic drawing data, and further sequentially groups a plurality of the group data into a higher level group data based on the break level, and registers the higher level group data at a higher hierarchy level next to a hierarchy level of the group data.

7. The computer-readable storage medium of claim 6, wherein the group data management section groups and registers the basic drawing data which being classified with one level lower break level than the determined break level and being not registered in the higher level group data or the group data.

8. The computer-readable storage medium of claim 6, wherein the break discrimination section receives, as the condition information, the distance between the screen of the handwritten data management apparatus and the input device and a time period when the input device is not contacting the handwritten data management apparatus, and determines the break level of the break portion, based on a value obtained with multiplying the distance by the time period.

9. The computer-readable storage medium of claim 6, wherein the break discrimination section receives, as the condition information, a gripping pressure of the input device, and determines the break level of the break portion, based on the gripping pressure.

10. The computer-readable storage medium of claim 6, wherein the break discrimination section receives, as the condition information, an inclination angle of the input device, and determines the break level of the break portion, based on the inclination angle.

11. A handwritten data management method for utilizing a handwritten data management system configured with an input device, and a handwritten data management apparatus having a screen on which the input device draws an image, comprising:
a drawing step of drawing on the screen of the handwritten data management apparatus by utilizing the input device;
a detecting step of detecting a condition of the input device;
a transmitting step of transmitting condition information of the input device to the handwritten data management apparatus;
a graphic data extracting step of extracting graphic data as basic drawing data from trajectories of the input device on the screen;
a break discrimination step of discriminating a break portion of the basic drawing data based on the condition information of the input device, and determining a break level of the break portion by referring to a previously stored table; and
a group data management step of grouping a plurality of the basic drawing data into a group data based on the break level, registering the group data at a higher hierarchy level next to a hierarchy level of the basic drawing data, and further sequentially grouping a plurality of the group data based on the break level into a higher level group data, and registering the higher level group data at a higher hierarchy level next to a hierarchy level of the group data.

12. The handwritten data management method of claim 11, wherein in the group data management step, the basic drawing data which being classified with one level lower break level than the determined break level and being not registered in the higher level group data, and the group data are grouped and registered.

13. The handwritten data management method of claim 11, wherein the input device comprises a distance measuring sensor to measure a distance between the screen of the handwritten data management apparatus and the input device; and a contact sensor to detect a contact between the screen and the input device, wherein
in the transmitting step, as the condition information, the distance between the screen of the handwritten data management apparatus and the input device, and a time period when the input device is not contacting the handwritten data management apparatus, are transmitted, and
in the break discrimination step, the break level of the break portion is determined based on a value obtained with multiplying the distance by the time period.

14. The handwritten data management method of claim 11, wherein the input device comprises a pressure sensor to measure a gripping pressure caused by an operator, wherein
in the transmitting step, the gripping pressure is transmitted as the condition information, and
in the break discrimination step, the break level of the break portion is determined based on the gripping pressure.

15. The handwritten data management method of claim 11, wherein the input device comprises an angle sensor to measure an inclination angle of the input device against a horizontal plane, and
in the transmitting step, the inclination angle is transmitted as the condition information, and
in the break discrimination step, the break level of the break portion is determined based on the inclination angle.
